(19) United States
(12) Patent Application Publication
(10) Pub. No.: US 2020/0031296 A1
(43) Pub. Date: Jan. 30, 2020

(54) AUTOMOBILE REAR BUMPER

(71) Applicant: Taizhou Huangyan JY-MO Engineering Co., Limited, Taizhou (CN)

(72) Inventors: Zhimin GE, Taizhou City (CN); Anyi HONG, Taizhou City (CN); An WANG, Taizhou City (CN)

(21) Appl. No.: 16/290,029

(22) Filed: Mar. 1, 2019

(30) Foreign Application Priority Data
Jul. 27, 2018 (CN) 201821203846.5

(51) Int. Cl. B60R 19/48; B60R 19/02; B60R 19/38

(52) U.S. Cl. CPC B60R 19/48; B60R 19/38; B60R 19/023

(57) ABSTRACT

An automobile rear bumper in a T-shaped structure comprises a pedal, a fixture, and a rotatable lid. The surface of the pedal is an arched platform which is flat in the middle and raised at both ends, and is provided with a vertically penetrating mounting hole in the center. The rotatable lid covers the mounting hole rotatably. Laterally penetrating fixing holes arranged in order are provided in the middle of the left and right sides of the fixture. The product is simple in structure, convenient to install, and safe in use.

### TECHNICAL FIELD

The utility model relates to the field of automobile parts, and in particular, to a rear collision prevention device for an automobile.

### BACKGROUND

People own increasingly more automobiles as the living standard improves gradually. While bringing many conveniences to people's life, the popularization of automobiles also causes more traffic accidents. Car accidents cast a severe shadow over people. To improve the safety of automobiles and reduce the harm caused by car accidents, a collision prevention device is generally installed at the rear of an automobile. However, the collision prevention effect and safety factor of existing collision prevention devices are not good enough, and only a single function is provided, which cannot meet other requirements of users.

### SUMMARY OF THE INVENTION

In view of the defects in the prior art, an objective of the utility model is to provide an automobile rear bumper, which is not only easy to step on but also can secure a sunshade while achieving a collision prevention function.

The utility model solves the technical problem by using the following technical solution: an automobile rear bumper, in a T-shaped structure and including a pedal, a fixture, and a rotatable lid; the surface of the pedal is an arched platform which is flat in the middle and raised at both ends, transverse anti-slip strips are arranged in order on the platform, and a vertically penetrating mounting hole is provided in the center of the platform; the rotatable lid covers the mounting hole rotatably; the interior of a rear side of the pedal is a hollowed-out structure, and at least two groups of slanting buffering ribs are disposed symmetrically at a top position in the interior of the rear side of the pedal; interlaced reinforcement ribs are disposed at a lower position in the interior of the rear side of the pedal; and several laterally penetrating fixing holes arranged in order are provided in the middle of left and right surfaces of the fixture.

Preferably, the rotatable lid is provided with a round of downward extending flange at an edge of a bottom surface, the periphery of the rotatable lid abuts against the top of an inner annular wall in the mounting hole, a buckle is disposed on an outer wall of the flange, a positioning hole is provided corresponding to an upper edge of the inner annular wall, a rotating groove for the buckle to enter and rotate is provided on the inner annular wall below the positioning hole, the rotating groove is in communication with the positioning hole, and the size of the rotating groove is greater than that of the positioning hole.

Preferably, anti-slip strips are disposed on both upper and lower surfaces of the fixture, and are close to left and right edges of the upper and lower surfaces, and the fixture is further provided with reinforcement holes on the left and right surfaces and close to upper and lower edges of the fixing holes.

Preferably, transverse ridges are disposed on the surface of the rotatable lid.

Preferably, the rear side of the fixture is provided with a recess at a joint with the pedal, and reinforcement ribs in cross and saltire are disposed in the recess.

Compared with the prior art, the utility model achieves the following beneficial effects: the product is simple in structure, convenient to install, and safe in use. The pedal achieves both a buffering function and a step-on function. The anti-slip design of the pedal can prevent injuries due to slipping, and the mounting hole opened in the center of the pedal can secure a sunshade. Therefore, the product can be used for multiple purposes.

### BRIEF DESCRIPTION OF THE DRAWINGS

FIG. 1 is an overall schematic structural diagram of an embodiment according to the utility model; and

FIG. 2 is a schematic structural diagram of a rear side of an embodiment according to the utility model.

### DETAILED DESCRIPTION

The utility model is described in further detail below with reference to the accompanying drawings and specific implementations.

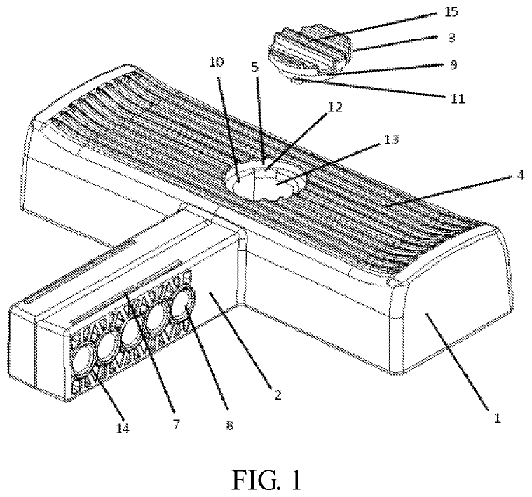

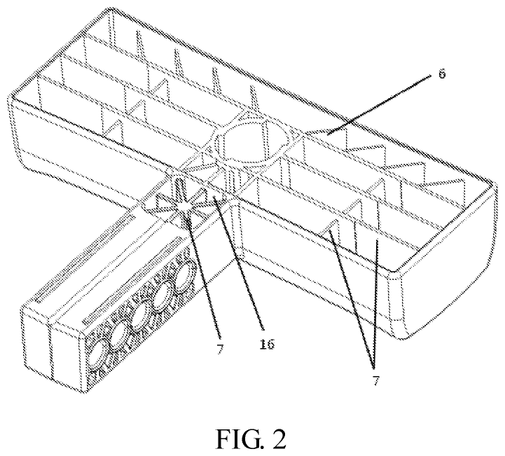

As shown in FIG. 1 to FIG. 2, the utility model provides an automobile rear bumper. The bumper is in a T-shaped structure with the overall dimensions as follows: a length of 310 mm, a width of 267 mm, and a height of 61 mm. The bumper includes a pedal 1, a fixture 2, and a rotatable lid 3.

Specifically, the surface of the pedal 1 is an arched platform which is flat in the middle and raised by 8.5 mm at both ends. Transverse anti-slip strips 4 are arranged in order on the platform. There are a total of 10 anti-slip strips 4, which are arranged at intervals of 5 mm A vertically penetrating mounting hole 5 is provided in the center of the platform. An outer annular wall of the mounting hole 5 has a diameter of 50 mm, and an inner annular wall thereof has a diameter of 40 mm. The rotatable lid 3 covers the mounting hole 5 rotatably. The interior of a rear side of the pedal 1 is a hollowed-out structure, and at least two groups of slanting buffering ribs 6 are disposed symmetrically at a top position in the interior of the rear side of the pedal 1. Each group includes four buffering ribs 6 that slant at an angle of 135°. Interlaced reinforcement ribs 7 are disposed at a lower position in the interior of the rear side of the pedal 1. The reinforcement ribs 7 include three transverse reinforcement ribs and four longitudinal reinforcement ribs. Several laterally penetrating fixing holes 8 arranged in order are provided in the middle of left and right surfaces of the fixture 2. There are 5 fixing holes each having a diameter of 16.6 mm, and the fixing holes are arranged at intervals of 6 mm.

The rotatable lid 3 is provided with a round of downward extending flange 9 at an edge of a bottom surface. The periphery of the rotatable lid 3 abuts against the top of an inner annular wall 10 in the mounting hole 5. A buckle 11 is disposed on an outer wall of the flange 9. A positioning hole 12 is provided corresponding to an upper edge of the inner annular wall 10. A rotating groove 13 for the buckle 11 to enter and rotate is provided on the inner annular wall 10 below the positioning hole 12. The rotating groove 13 is in communication with the positioning hole 12, and the size of the rotating groove 13 is greater than that of the positioning hole 12. In special cases such as exposure to the blazing sun and heavy rain, the rotatable lid 3 can be removed to secure a sunshade in the hole, so that the product can be used for multiple purposes.

Anti-slip strips 4 are disposed on both upper and lower surfaces of the fixture 2, and are close to left and right edges of the upper and lower surfaces. The fixture 2 is further provided with reinforcement holes 14 on the left and right surfaces and close to upper and lower edges of the fixing holes 8. The reinforcement holes 14 may be triangular or rectangular, as long as they can enhance the strength.

Transverse ridges 15 are disposed on the surface of the rotatable lid 3. The ridges 15 help a user rotate the lid conveniently.

The rear side of the fixture 2 is provided with a cubic recess 16 at a joint with the pedal 1, and the recess 16 has a length of 38 mm and a depth of 45 mm Reinforcement ribs 7 in cross and saltire are disposed in the recess 16. The joint between the fixture 2 and the pedal 1 is relatively weak, and the reinforcement ribs 7 can enhance the strength significantly, so as to prevent the fixture 2 and the pedal 1 from fracturing when the automobile is impacted.

In use, a square-shaped fixing frame is first installed at the rear of the automobile, and then the fixture of the bumper is inserted into the fixing frame and is further inserted into the fixing hole through a pin, so as to be locked. When a user does not properly control the distance during backing, the buffering area at the front end of the bumper is squeezed under collision. The buffering area greatly reduces the impact force, thereby avoiding damage to the rear of the car to some extent. At ordinary times, the bumper can also be used as a pedal. In the case of exposure to the blazing sun, heavy rain, or other special weather, a sunshade can be secured merely after removing the rotatable lid by rotating.

It can be known from the common technical knowledge that the utility model can be implemented through other implementation solutions without departing from the spirit essence or necessary characteristics thereof. Therefore, from various aspects, the implementation solution disclosed above is merely an example for illustration, and is not exclusive. All changes in the scope of the utility model or in equivalent scopes of the utility model are encompassed in the utility model.

1. An automobile rear bumper, in a T-shaped structure and comprising a pedal, a fixture, and a rotatable lid, wherein the surface of the pedal is an arched platform which is flat in the middle and raised at both ends, transverse anti-slip strips are arranged in order on the platform, and a vertically penetrating mounting hole is provided in the center of the platform; the rotatable lid covers the mounting hole rotatably; the interior of a rear side of the pedal is a hollowed-out structure, and at least two groups of slanting buffering ribs are disposed symmetrically at a top position in the interior of the rear side of the pedal; interlaced reinforcement ribs are disposed at a lower position in the interior of the rear side of the pedal; and several laterally penetrating fixing holes arranged in order are provided in the middle of left and right surfaces of the fixture.

2. The automobile rear bumper according to claim 1, wherein the rotatable lid is provided with a round of downward extending flange at an edge of a bottom surface, the periphery of the rotatable lid abuts against the top of an inner annular wall in the mounting hole, a buckle is disposed on an outer wall of the flange, a positioning hole is provided corresponding to an upper edge of the inner annular wall, a rotating groove for the buckle to enter and rotate is provided on the inner annular wall below the positioning hole, the rotating groove is in communication with the positioning hole, and the size of the rotating groove is greater than that of the positioning hole.

3. The automobile rear bumper according to claim 1, wherein anti-slip strips are disposed on both upper and lower surfaces of the fixture, and are close to left and right edges of the upper and lower surfaces, and the fixture is further provided with reinforcement holes on the left and right surfaces and close to upper and lower edges of the fixing holes.

4. The automobile rear bumper according to claim 2, wherein transverse ridges are disposed on the surface of the rotatable lid.

5. The automobile rear bumper according to claim 2, wherein the rear side of the fixture is provided with a recess at a joint with the pedal, and reinforcement ribs in cross and saltire are disposed in the recess.
